(19) United States
(12) Patent Application Publication
(10) Pub. No.: US 2003/0230982 A1
(43) Pub. Date: Dec. 18, 2003

(54) Dimmer light switch device for high power applications

(76) Inventors: Bruce Pagano, Pompano Beach, FL (US); James Pagano, Pompano Beach, FL (US); Steve Wong Kwok Din, Kowloon Bay, Kowloon (CN)

Correspondence Address: David P. Lhota, Stearns Weaver Miller, et al., Suite 1900, 200 East Broward Boulevard, Fort Lauderdale, FL, 33301, US

(21) Appl. No.: 10/170,940

(22) Filed: Jun. 13, 2002

(51) Int. Cl. H01K 1/62

(52) U.S. Cl. 315/56; 315/DIG. 4

(57) ABSTRACT

A light switch dimmer device for operating and controlling a current supply to a lighting fixture up to seven hundred (700) watts wherein the light switch dimmer includes a mean for receiving power, a triac, a trigger diode electrically connected to the triac, an RC circuit component shunt, and a variable resistor between 300k ohms and 500k ohms for controlling the voltage to the trigger diode which controls the phase of the triac thereby dictating the voltage applied to a light fixture load. The dimmer may comprise a one-way or three-way switch.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates generally to a dimmer light switch, and more particularly to a dimmer light switch device having higher efficiency in operating and controlling current supply to a lighting fixture up to seven hundred (700) watts.

2. Description of the Background Art

Dimmer switches for incandescent and fluorescent lights and inductive loads, such as fans, are well known in the art. Conventional dimmer switches typically use variable resistors, such as potentiometers connected to a manually operated dimmer knob, to vary the firing angle of a thyristor to control the AC power source delivered to a load. With respect to lighting fixtures, these types of dimmer switches are commonly used for low wattage lamps, such as sixty (60) watts to hundred (100) watts, and are ineffective and inefficient for larger resistive loads, such as lamp loads in the seven hundred (700) watt range.

There are two types of dimmer switches known for controlling larger light fixture loads. The first dimmer uses a triac that can only control the current supply to lighting fixtures up to 600 watts. The second dimmer switch known uses a silicon-controlled rectifier (SCR), which is less efficient than the triac as it can only provide half wave control. Triacs provide the preferred full wave technology, but are limited to loads less than 600 watts. A dimmer switch capable of employing full wave technology for controlling incandescent and resistance loads up to 700 watts would be more efficient than dimmers known in the art. Accordingly, there exist a need for a more efficient dimmer switch that operates in the 700-watt range.

While various advances have been made in dimmer technology to address problems related to energy conservation and efficiency, there still remains a need for a dimmer that can efficiently control current to lighting fixtures over 600 watts. The instant invention addresses this need by providing a dimmer switch for incandescent and resistance loads up to 700 watts that provides higher efficiency than conventional dimmer technology, such as that offered by circuit designs using SCR's.

### BRIEF SUMMARY OF THE INVENTION

Based on the foregoing, it is a primary object of the instant invention to provide a dimmer switch that can control the current supply to incandescent and resistance loads up to 700 watts.

It is an object of the instant invention to provide a one-way, three-way combination dimmer switch that can control the current supply to incandescent and resistance loads up to 700 watts.

It is another object of the instant invention to provide a dimmer switch that can employ full wave triac technology for efficiently operating current supply to loads up to 700 watts.

It is also an object of the instant invention to provide a dimmer switch that can employ triac full wave technology in dimmer switches for loads up to 700 watts with more efficiency than dimmers circuits using SCR technology.

It is a further object of the instant invention to provide a dimmer switch for lighting fixtures up to 700 watts that is lower in costs and higher in efficiency than conventional dimmers.

It is an additional object of the instant invention to provide a dimmer switch for lighting fixtures up to 700 watts that is useable with single pole and three-way control lighting fixtures.

In light of these and other objects the instant invention provides a dimmer switch for controlling the current supply to lighting fixtures having incandescent and resistance loads up to 700 watts. The dimmer switch preferably comprises a one-way, three-way combination, variable control dimmer for applications up to 700 watts. The dimmer switch preferably employs a full wave triac for controlling current supply to loads up to 700 watts, a housing that encloses the circuit and a switch for controlling a variable resistive load. The circuit preferably includes a triac rated at twelve (12) amps and six hundred (600) volts, a variable resistor in the range of 300k to 500k ohms and a 104/250 VAC capacitor connected to a 10k ohm resister. The triac in combination with the variable resistor and 104/250 VAC capacitor provides full wave control yielding higher efficiency than large load dimmers employing SCR's and half-wave technology. A variable 500k-ohm resistor is provided for fine adjustment of low setting outputs such as in the 230-260 watt range.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a front perspective view of the preferred embodiment of the dimmer light switch device of the instant invention.

FIG. 2 is a bottom elevational view of the preferred embodiment of the dimmer light switch device of the instant invention illustrating the wire leads.

FIG. 3 is a block diagram of the preferred embodiment of the dimmer light switch device of the instant invention.

FIG. 4 is an electrical circuit diagram of the dimmer switch circuit in accordance with the preferred embodiment of the instant invention.

FIG. 5 is a block diagram of an alternative embodiment of the dimmer light switch device of the instant invention.

FIG. 6 is an electrical circuit diagram of the dimmer switch circuit in accordance with the alternative embodiment of the instant invention.

### DETAILED DESCRIPTION OF THE INVENTION

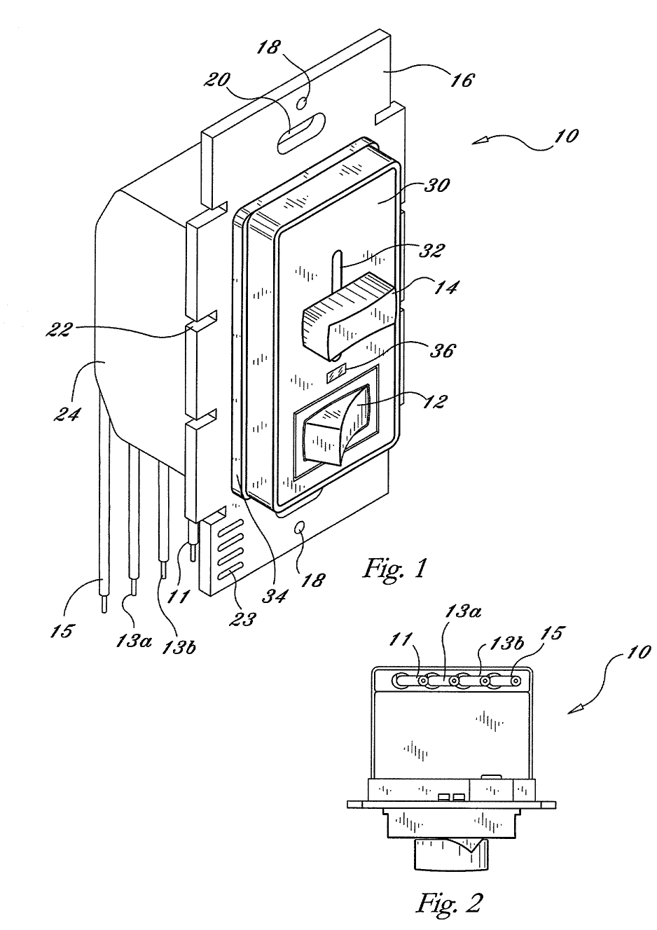

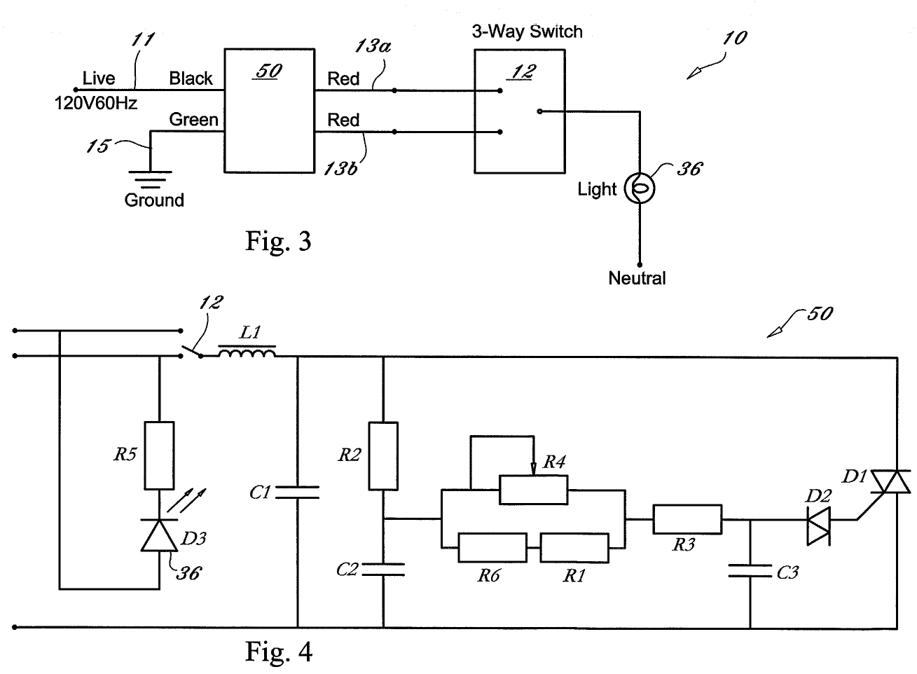

With reference to the drawings, FIGS. 1-6 depict the preferred embodiment of the dimmer light switch device of the instant invention, which is generally characterized as a dimmer switch or by reference numeral 10. The instant invention 10 comprises a one-way, three-way combination dimmer for controlling high power loads up to approximately 700 watts. Accordingly, the dimmer switch 10 can operate incandescent and resistance loads and may be employed with single pole and three-way control lighting fixtures. Referring to FIG. 1, the dimmer switch 10 comprises an on/off switch 12, slidable dimmer knob 14, mounting plate 16, housing 24, face plate 30, light emitting diode (LED) 36, wire leads 11, 13 and 15, and dimmer switch circuit 50 (shown in FIG. 3). In the preferred embodiment, the power switch 12 comprises a three-pole, multiple throw switch having four leads 11, 13a, 13b and 15. The three pole switch 12 provides a first or “off” position and second, third and fourth “on” positions for three different levels of power. In the “off” position, the LED 36 is illuminated for facilitating the locating of the switch in a dark room. In an alternative embodiment, the power switch 12 may comprise a single pole, single throw (SPST) switch that may be alternated between a first or “off” position for powering the switch locator LED D3, 36 and a second or “on” position for supplying power to the remaining portion of the circuit which controls the load.

The power switch 12 preferably provides 110-120 VAC to the dimmer switch 10 circuit 50. The housing 24 contains, conceals and protects the dimmer switch circuit 50 and facilitates electrical connection and communication with the circuit 50 through wire leads 11, 13a, 13b, 15 that project outward from the housing 24, as shown in FIGS. 1 and 2. The wire lead denoted numeric character 15 comprises a ground wire and wire leads 13a, 13b and 11 are used for connecting to a source of AC power. The wire leads 11, 13a, 13b and 15 are preferably color coded in accordance with industry standards for identifying where and how they should be connected to a source of power. For instance, the ground wire lead 15 is preferably green and wire leads 11 and 13 are preferably red and/or black.

Referring to FIG. 1, the mounting plate 16 includes a plurality of slots 22 and apertures 18, 20 that may be selectively used for mounting the dimmer switch 10 to a fixed structure, such as an existing wall plate or frame. The mounting plate 16 may also include a plurality of apertures 23 that may be used for creating, providing or facilitating a heat sink. The faceplate 30 has tabs (not shown) that snap into corresponding apertures defined by the mounting plate 16. The faceplate 30 includes an elongated slot 32 that receives and facilitates slidable movement of the dimmer knob 14, which is connected to a post (not shown) that intersects the slot 32. The post is in mechanical communication with the circuit's 50 variable resister R4 (shown in FIG. 3) so that movement of the dimmer knob 14 adjusts the power supplied to the triac D1 and hence the controlled load. In order to facilitate receiving power, the power switch 12 must be actuated to one of the “on” positions, also referenced as the second, third and fourth positions. The dimmer switch 10 includes the LED 36, which is illuminated when the power switch 12 is in the “off” or first position. This makes the dimmer switch 10 visible in a dark or dimly lit room so that the switch 10 may be easily located and accessed.

With reference to FIG. 3, the dimmer switch circuit 50 preferably comprises a triac D1 having first, second and third (gate) terminals rated at approximately twelve (12) amps and six hundred (600) volts, variable resistor R4 in a range of approximately 300k-500k ohms, capacitor C2 connected to ground and a resistor R2 of approximately 10k ohms and additional signal conditioning components as referenced herein. Referring to FIG. 3, the power switch 12 has four positions. In an “off” position, power is supplied to LED 36, D3 and resistor R5 to energize the LED 36, D3 light source when the dimmer switch 10 is off. This allows the switch 10 to be conveniently located in a dark room with minimum power consumption. In the second, third and fourth “on” positions, power is supplied at different levels to the remaining portion of the circuit 50 for providing three-way control. The circuit 50 also comprises an inductor L1, a capacitor C1 connected to ground and inductor L1, resistor R2 and capacitor C2 connected in parallel to capacitor C1, variable resistor R4 connected in parallel to resistors R1 and R6 and connected to resistor R2 and capacitor C2 at one end and resistor R3 at the other end, a grounding capacitor C3 connected to resistor R3, a diac D2 connected to resistor R3 and capacitor C3 and triac D1 connected to a two-terminal diac D2, ground and inductor L1. The inductor L1 is preferably rated at approximately 28 micro-henrys and ten (10) amperes. Capacitors C1 and C2 are preferably rated at approximately 104/250 VAC. Resistor R1 preferably comprises a 500k-ohm variable resistor to provide fine adjustments of the power output at lower settings, such as in the 230 to 260 watt range. Resistor R6 preferably comprises approximately 100k ohms. Resistors R2 and R3 preferably comprise approximately 10k ohms and 5.6k ohms, respectively. Variable resistor R4 is preferably rated at approximately 300k ohms to 500k ohms. Capacitor C3 is preferably rated at approximately 473/250 VAC. Triac D1 may comprise a triac sold as part number BTA12-500 and diac D2 may comprise a diac sold as part number DB3.

The dimmer switch 10 controls the current supply to incandescent and resistance loads up to 700 watts by controlling the firing voltage of the diac D2 and triac D1. The capacitors C2 and C3 are charged to a particular voltage level and contribute to the firing voltage of the diac D2. The variable resistor R4 controls the firing voltage of the trigger diode or diac D2, which controls the phase of the triac D1. By controlling the phase of triac D1, the triac D1 changes the voltage applied to the load, such as a resistance lamp load, and hence the intensity of the light generated by the load. The inductor L1 assists in providing a stable light intensity by maintaining the selected voltage levels. The triac D1 uses full wave technology to control the voltage supplied to a load. The values of diac D2, triac D1 and inductor L1 provide for proper operation of the dimmer switch 10 of the instant invention.

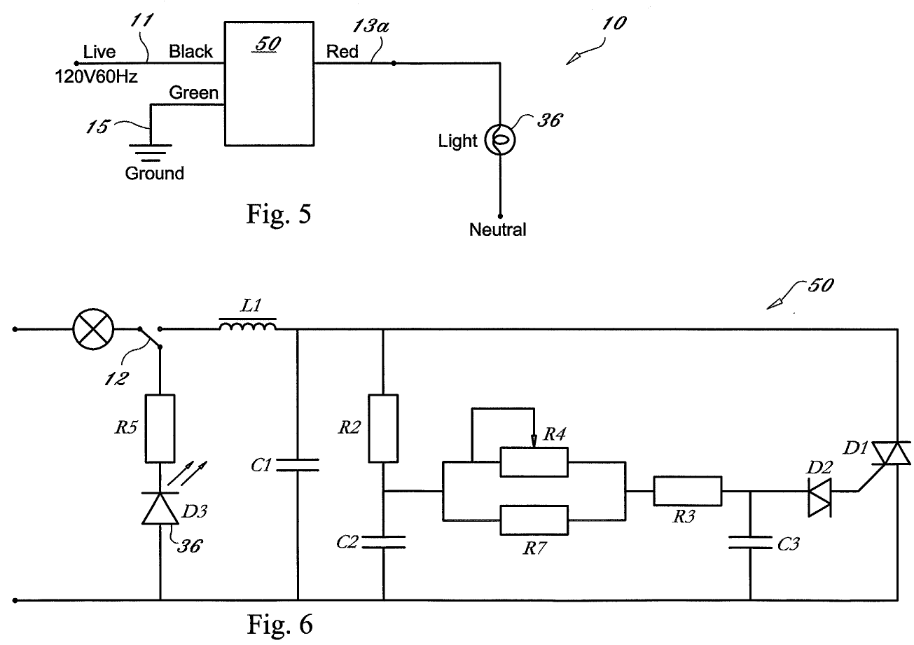

With reference to FIGS. 5 and 6, the alternative embodiment of the instant invention 10 comprises a single pole dimmer for use in high wattage applications, such as up to approximately 700 watts. The alternative switch 10 comprises three leads 11, 13 and 15, as shown in FIG. 5. The alternative circuit 50 eliminates resistor R6 and replaces resistor R1 with a fixed resistor R7 of approximately 226 k ohms. The switch 12 is also replaced by a single pole, single throw (SPST) switch.

The instant invention has been shown and described herein in what is considered to be the most practical and preferred embodiment. It is recognized, however, that departures may be made therefrom within the scope of the invention and that obvious structural and/or functional modifications will occur to a person skilled in the art.

What is claimed is:

1. A dimmer switch for controlling resistance and incandescent lighting fixture loads up to approximately 700 watts to control the intensity of the light emanated by the lighting fixture load, said dimmer switch comprising:
power means for receiving power and providing a voltage source to drive the lighting fixture load;
triac means, in electrical communication with said power means, for controlling the voltage applied to the lighting fixture load to adjust the light intensity emanated therefrom;
a resistance and capacitance combination in electrical communication with said power means and said triac means; and
triac control means, in electrical communication with said triac means, for controlling the output of the triac means.

2. A dimmer switch as recited in claim 1, wherein said triac means comprises:
a triac in electrical communication with said power means and rated at approximately twelve amperes and six hundred volts.

3. A dimmer switch as recited in claim 1, wherein said triac control means comprises:
phase control means, in electrical communication with said triac means, for controlling the phase of said triac means; and
an adjustable resistance means, in electrical communication with said phase control means and said resistance and capacitance combination, for controlling the voltage applied to said phase control means phase of said triac means, said adjustable resistance means comprising a variable resistor being adjustable in an approximate range of three hundred thousand ohms and five hundred thousand ohms.

4. A dimmer switch as recited in claim 3, wherein said phase control means comprises:
a trigger diode being in electrical communication with said variable resistor and said triac means.

5. A dimmer switch as recited in claim 1, wherein said resistance and capacitance combination comprises:
a resistor rated at approximately ten thousand ohms; and
a capacitor electrically connected to said resistor, said capacitor being rated at approximately 104/250VAC.

6. A dimmer switch as recited in claim 1, further comprising:
means, in electrical communication with said power means and said triac means, for stabilizing the light intensity of the light emanated from the light fixture load.

7. A dimmer switch as recited in claim 6, wherein said stabilizing means comprises:
an inductor having an inductance rating of approximately twenty-eight micro-henrys, said inductor being electrically connected to said power means and said triac means.

8. A dimmer switch for controlling resistance and incandescent lighting fixture loads up to approximately 700 watts to control the intensity of the light emanated by the lighting fixture load, said dimmer switch comprising:
power means for receiving power and providing a voltage source to drive the lighting fixture load;
triac means, in electrical communication with said power means, for controlling the voltage applied to the lighting fixture load to adjust the light intensity emanated therefrom, said triac means including a triac in electrical communication with said power means and rated at approximately twelve amperes and six hundred volts;
a resistance and capacitance combination in electrical communication with said power means and said triac means; and
triac control means, in electrical communication with said triac means, for controlling the output of the triac means.

9. A dimmer switch as recited in claim 8, wherein said triac control means comprises:
an adjustable resistance means, in electrical communication with said triac and said resistance and capacitance combination, for facilitating control of the phase of said triac, said adjustable resistance means comprising a variable resistor being adjustable in an approximate range of three hundred thousand ohms and five hundred thousand ohms.

10. A dimmer switch as recited in claim 9, wherein said phase control means further comprises:
a trigger diode being in electrical communication with said variable resistor and said triac means for controlling the phase of said triac means, said variable resistor controlling the voltage of said trigger diode.

11. A dimmer switch as recited in claim 8, wherein said resistance and capacitance combination comprises:
a resistor rated at approximately ten thousand ohms being electrically connected to said phase control means and said triac means; and
a capacitor electrically connected to said resistor and said triac, said capacitor being rated at approximately 104/250VAC.

12. A dimmer switch as recited in claim 8, further comprising:
inductance means, in electrical communication with said power means and said triac means, for stabilizing the light intensity of the light emanated from the light fixture load.

13. A dimmer switch as recited in claim 12, further comprising a capacitance shunt electrically connected to said inductance means, resistance and capacitance combination and said triac.

14. A dimmer switch for controlling resistance and incandescent lighting fixture loads up to approximately 700 watts to control the intensity of the light emanated by the lighting fixture load, said dimmer switch comprising:
power means for receiving power and providing a voltage source to drive the lighting fixture load;
triac means, in electrical communication with said power means, for controlling the voltage applied to the lighting fixture load to adjust the light intensity emanated therefrom;
a resistance and capacitance combination in electrical communication with said power means and said triac means; and
triac control means, in electrical communication with said triac means, for controlling the phase of the triac means and comprising a variable resistor being adjustable in the approximate range of 300 thousand ohms to 500 thousand ohms and in electrical communication with said resistance and capacitance combination.

15. A dimmer switch as recited in claim 14, wherein said triac means comprises:
a triac in electrical communication with said power means and rated at approximately twelve amperes and six hundred volts.

16. A dimmer switch as recited in claim 15, wherein said resistance and capacitance combination comprises:
a resistor rated at approximately ten thousand ohms and a capacitor rated at approximately 104/250 VAC, said resistor and said capacitor being electrically connected to said variable resistor and said triac.

17. A dimmer switch as recited in claim 14, wherein said triac control means comprises:
a trigger diode being in electrical communication with said variable resistor and said triac means, said variable resistor controlling the voltage to said trigger diode, said trigger diode controlling the phase of said triac means.

18. A dimmer switch as recited in claim 17, wherein said triac control means further comprises:
a resistor of approximately 226 ohms electrically connected in parallel to said variable resistor; and
a resistor of approximately 5.6 thousand ohms being electrically connected to said variable resistor and said trigger diode.

19. A dimmer switch as recited in claim 14, further comprising:
inductance means, in electrical communication with said power means and said triac means, for stabilizing the light intensity of the light emanated from the light fixture load.

20. A dimmer switch as recited in claim 18, further comprising a capacitance shunt electrically connected to said inductance means, resistance and capacitance combination and said triac.

21. A dimmer switch as recited in claim 14, further comprising:
illumination means, electrically and releasably connected to said power means, for selectively illuminating said switch.

22. A dimmer switch as recited in claim 21, wherein said illumination means comprises:
a light emitting diode releasably and electrically connected to said power means for receiving power when said power means is in an off position that removes power from said triac means.
